(19) United States
(12) Patent Application Publication
(10) Pub. No.: US 2021/0390433 A1
(43) Pub. Date: Dec. 16, 2021

(54) Method For Automated Assistance With A Recording Of A Repair Of A Motor-Driven Tool, And System For Automated Assistance With A Recording Of A Repair Of A Motor-Driven Tool

(71) Applicant: Andreas Stihl AG & Co. KG, Waiblingen (DE)

(72) Inventors: Robert BOEKER, Waiblingen (DE); Vanessa ORENDI, Ostfildern (DE); Deziderio SONJE, Stuttgart (DE); Jonas BLERSCH, Stuttgart (DE)

(21) Appl. No.: 17/343,159

(22) Filed: Jun. 9, 2021

(30) Foreign Application Priority Data
Jun. 10, 2020 (EP) 20179363.5

(51) Int. Cl. G06N 5/04; B23P 6/00

(52) U.S. Cl. CPC G06N 5/043; B23P 6/00

(57) ABSTRACT

A method provides automated assistance with a recording of a repair of a motor-driven tool. The method a) ascertains at least one component of the tool, at least one assembly group of the tool, and/or at least one component and/or assembly-group type of at least one component and/or at least one assembly group, wherein the component and/or the assembly group have been handled during the repair of the tool, b) determines a number of possible actions carried out during the repair of the tool on the basis of the ascertained component, the ascertained assembly group and/or the ascertained component and/or assembly-group type, and c) outputs the determined number of possible actions.

### CROSS REFERENCE TO RELATED APPLICATION

This application claims priority under 35 U.S.C. § 119 from European Patent Application No. 20179363.5, filed Jun. 10, 2020, the entire disclosure of which is herein expressly incorporated by reference.

### BACKGROUND AND SUMMARY OF THE INVENTION

The invention relates to a method for automated assistance with a recording of a repair of a motor-driven tool and to a system for automated assistance with a recording of a repair of a motor-driven tool.

The invention is based on the object of providing a method for automated assistance with a recording of a repair of a motor-driven tool and a system for automated assistance with a recording of a repair of a motor-driven tool, each of which has improved properties.

The invention achieves this object by providing a method and/or a system having the features of the independent claims. Advantageous developments and/or configurations of the invention are described in the dependent claims.

The method according to the invention is designed or configured for automated assistance, or support, with a recording of a repair of or overhaul of a motor-driven tool. The method comprises, or involves, the steps of: a) ascertainment, in particular automated ascertainment, in particular recording and/or receiving, of at least one component, in particular information about the component, of the tool and/or of at least one assembly group, in particular information about the assembly group, of the tool and/or of at least one component and/or assembly-group type, in particular information about the component and/or assembly-group type, of at least one, in particular the at least one, component and/or at least one, in particular the at least one, assembly group, wherein the component and/or the assembly group have/has been handled during, in particular for, the repair of the tool, in particular by a repairer of the tool, in particular directly; b) determination, in particular automated determination, of a number, in particular a plurality, of possible actions, in particular information about the number of possible actions, in particular by the repairer, carried out during, in particular for, the repair of the tool on the basis of, in particular only, the ascertained component, in particular the ascertained information about the component, and/or the ascertained assembly group, in particular the ascertained information about the assembly group, and/or the ascertained component and/or assembly-group type, in particular the ascertained information about the component and/or assembly-group type, in particular and/or not on the basis of a symptom; c) output, in particular automated output, of the determined number of possible actions, in particular the ascertained information about the number of possible actions, in particular to the repairer.

This, in particular the ascertainment of the component and/or the assembly group and/or the component and/or assembly-group type, allows the determination of the number of possible actions, in particular indirectly. Additionally or alternatively, this, in particular the output of the determined number of possible actions, allows the repair to be able to be recorded quickly and therefore inexpensively, in particular by the repairer. In particular, this assistance with the recording of the repair may appear awkward, in particular the ascertainment of the component and/or the assembly group and/or the component and/or assembly-group type and the determination of the number of possible actions on the basis thereof like a circuitous route, in particular in contrast to a direct ascertainment, in particular recording, of, in particular actual, actions carried out during the repair of the tool. Surprisingly, however, this can allow the recording of the repair to be cut short or shortened.

In particular, the tool can be a hand-held, in particular hand-portable, and/or ground-based tool. In particular, hand-held, in particular hand-portable, tool can mean that the tool can have a mass of no more than 50 kilograms (kg), in particular of no more than 20 kg, in particular of no more than 10 kg, in particular of no more than 5 kg, and/or of no less than 1 kg, in particular of no less than 2 kg. Additionally or alternatively, the tool can be a garden, forestry and/or construction tool.

The component can be a replacement part and/or the assembly group can be a replacement group, the replacement part and/or the replacement group having been swapped in the tool, in particular swapped in or out, or replaced or installed, in particular installed or removed, during the repair of the tool. Additionally or alternatively, the component and/or assembly-group type can be a replacement-part and/or replacement-group type of at least one, in particular the at least one, replacement part and/or of at least one, in particular the at least one, replacement group.

Handled can mean cleaned and/or inspected.

The number of possible actions can comprise, in particular be, a number of possible cleaning, inspection, swapping and/or repair actions. Additionally or alternatively, the number of possible actions can comprise, in particular be, a number of possible actions carried out on the component and/or the assembly group and/or one and/or another component, in particular of the same assembly group, and/or assembly group that is functionally related to or interacts with the component and/or the assembly group, in particular precedes said component and/or assembly group. More additionally or alternatively, in the case of the replacement part and/or the replacement group, the number of possible actions can comprise, in particular be, a number of possible actions, in particular cleaning, inspection and/or repair actions, of the, in particular swapped, or replaced, component and/or of the, in particular swapped, or replaced, assembly group.

The ascertained component and/or the ascertained assembly group and/or the ascertained component and/or assembly-group type can be taken as a basis for determining the number of possible actions, and another ascertained component and/or another ascertained assembly group and/or another ascertained component-type and/or assembly-group type can be taken as a basis for determining another number of possible actions.

The output can comprise, in particular be, an audible and/or visual output, in particular a display.

Step b) can be carried out at a time after step a). Additionally or alternatively, step c) can be carried out at a time after step b).

In one development of the invention, the number of possible actions is user-confirmable, in particular user-selectable. The method comprises, or involves, the steps of: d) confirmation, in particular selection, or picking, of at least one, in particular actual, action, in particular information about the action, from the output number of possible actions, in particular the output information about the number of possible actions, in particular by the repairer; e) storage, in particular automated storage, of the confirmed, in particular selected, action, in particular the confirmed information about the action. The determination of the number of possible actions on the basis of the ascertained component and/or the ascertained assembly group and/or the ascertained component and/or assembly-group type allows the number of possible actions to be small, in particular smaller than a plurality of all, or all of the, possible actions carried out during a repair of the tool, in particular determined on the basis of, in particular only, an ascertained tool type of the tool. This allows the repairer to receive, in particular only, the, in particular small, number of possible actions as an output and to have to confirm, in particular select, in particular only, in, in particular from, these. This therefore allows the repair to be recorded quickly. Additionally or alternatively, the storage allows the recording of the repair. In particular, step d) can be carried out at a time after step c). Additionally or alternatively, step e) can be carried out at a time after step d).

In particular, the method can comprise, or involve, the step of: storage, in particular automated storage, of the ascertained component, in particular the ascertained information about the component, and/or the ascertained assembly group, in particular the ascertained information about the assembly group, and/or the ascertained component and/or assembly-group type, in particular the ascertained information about the component and/or assembly-group type.

In one configuration of the invention, the method comprises, or involves, the step of: f) output, in particular automated output, and/or transmission, in particular automated transmission, of the stored action, in particular the stored information about the action, in particular and the ascertained, in particular and stored, component, in particular the ascertained information about the component, and/or the ascertained, in particular and stored, assembly group, in particular the ascertained information about the assembly group, and/or the ascertained, in particular and stored, component and/or assembly-group type, in particular the ascertained information about the component and/or assembly-group type, in particular to the repairer and/or a user of the tool. In particular, the output can comprise, in particular be, an audible and/or visual output, in particular a display. Additionally or alternatively, the transmission can comprise, in particular be, a wireless transmission. More additionally or alternatively, step f) can be carried out at a time after step e).

In one development, in particular one configuration, the invention comprises, or has, step b): determination, in particular automated determination, of a number, in particular a plurality, of required, or inevitable, actions, in particular information about the number of required actions, in particular by the repairer, carried out during, in particular for, the repair of the tool on the basis of, in particular only, the ascertained component, in particular the ascertained information about the component, and/or the ascertained assembly group, in particular the ascertained information about the assembly group, and/or the ascertained component and/or assembly-group type, in particular the ascertained information about the component and/or assembly-group type, in particular and/or not on the basis of a symptom. Step c) and/or step f), where present, comprise/comprises, or involve/involves: output, in particular automated output, and/or transmission, in particular automated transmission, of the determined number of required actions, in particular the determined information about the number of required actions, in particular to the repairer and/or the user. This allows complete recording of the repair. In particular, the number of possible actions and the number of required actions can be different, in particular of different type. Additionally or alternatively, in the case of the replacement part and/or the replacement group, the number of required actions can comprise, in particular be, a number of required swapping actions. More additionally or alternatively, the method can comprise, or involve, the step of: storage, in particular automated storage, of the determined number of required actions, in particular the determined information about the number of required actions.

In one development, in particular one configuration, of the invention, the method comprises, or involves, the step of: ascertainment, in particular automated ascertainment, in particular recording and/or receiving, of a tool type, in particular information about the tool type, of the tool. Step b) comprises, or involves: determination, in particular automated determination, of the number of possible actions, in particular the information about the number of possible actions, and/or the number of required actions, in particular the information about the number of required actions, where available, on the basis of the ascertained tool type, in particular the ascertained information about the tool type. This allows a determination, in particular and an output, of impossible actions to be avoided. This therefore allows the number of possible actions to be particularly small. Additionally or alternatively, this allows a particularly complete recording of the repair. In particular, the component and/or the assembly group can be used for, in particular in, different tool types of motor-driven tools, wherein, in particular different, numbers of different, in particular different types of, actions may be possible and/or required in the case of, or for, the different tool types. Additionally or alternatively, the tool type can be from a set of different tool types of motor-driven tools. More additionally or alternatively, the ascertainment of the tool type of the tool can comprise, or involve: selection, in particular automated selection, or picking, in particular only, of the, in particular single, tool type of the tool from a set of different tool types of motor-driven tools, in particular by the repairer.

In one development of the invention, the method comprises, or involves, the step of: ascertainment, in particular automated ascertainment, in particular recording and/or receiving, of a, in particular the, tool type, in particular information about the tool type, of the tool. The method comprises, or involves, the step of: determination, in particular automated determination, of a user-selectable plurality of possible component and/or assembly-group types, in particular user-selectable information about the plurality of possible component and/or assembly-group types, of possible components and/or possible assembly groups, handled during, in particular for, the repair of the tool, in particular by the repairer, in particular directly, on the basis of the ascertained tool type, in particular the ascertained information about the tool type. The method comprises, or involves, the step of: output, in particular automated output, of the determined plurality of possible component and/or assembly-group types, in particular the determined information about the plurality of possible component and/or assembly-group types. Step a) comprises, or involves: selection, or picking, of the component and/or assembly-group type, in particular the information about the component and/or assembly-group type, from the output plurality of possible component and/or assembly-group types, in particular the output information about the plurality of possible component and/or assembly-group types, in particular by the repairer. This allows a determination, in particular and an output, of impossible component and/or assembly-group types to be avoided. It therefore allows the plurality of possible component and/or assembly-group types to be small. It therefore allows the repair to be recorded quickly. In particular, different tool types of motor-driven tools can comprise different, in particular different types of, component and/or assembly-group types of components and/or assembly groups. Additionally or alternatively, the tool type can be from a set of different tool types of motor-driven tools. More additionally or alternatively, the ascertainment of the tool type of the tool can comprise, or involve: selection, in particular automated selection, or picking, in particular only, of the, in particular single, tool type of the tool from a set of different tool types of motor-driven tools, in particular by the repairer.

In one development, in particular one configuration, the invention comprises, or has, step b) of: picking, in particular automated picking, or selection, of the number of possible actions, in particular the information about the number of possible actions, and/or the number of required actions, in particular the information about the number of required actions, where available, from a set of different actions, in particular different information about the actions, wherein the actions, in particular the information about the actions, are/is assigned in each case at least one component, in particular information about the component, from a set of different components, in particular different information about the components, and/or at least one assembly group, in particular information about the assembly group, from a set of different assembly groups, in particular different information about the assembly groups, and/or at least one component and/or assembly-group type, in particular information about the component and/or assembly-group type, of a component and/or an assembly group from a set of different component and/or assembly-group types, in particular different information about the component and/or assembly-group types, of components and/or assembly groups, in particular and at least one tool type, in particular information about the tool type, of a motor-driven tool from a set of different tool types, in particular different information about the tool types, of motor-driven tools, where available. Additionally or alternatively, the determination of the plurality of possible component and/or assembly-group types, where present, comprises, or involves: picking, in particular automated picking, or selection, of the plurality of possible component and/or assembly-group types, in particular the information about the plurality of possible component and/or assembly-group types, from a set of different component and/or assembly-group types, in particular different information about the component and/or assembly-group types, of components and/or assembly groups, wherein the component and/or assembly-group types, in particular the information about the component and/or assembly-group types, are/is assigned in each case at least one tool type, in particular information about the tool type, of a motor-driven tool from a set of different tool types, in particular different information about the tool types, of motor-driven tools. This allows the determination of the number of possible actions and/or the number of required actions and/or the plurality of possible component and/or assembly-group types on the basis of the ascertained component and/or the ascertained assembly group and/or the ascertained component and/or assembly-group type and/or the ascertained tool type.

In one development, in particular one configuration, of the invention, step a) and/or step d), where present, and/or the ascertainment of the tool type, where present, comprise/comprises, or involve/involves, a touch-based, or touch-sensitive, or haptic, and/or audible input, in particular by the repairer. This allows a high level of repair friendliness. In particular, the touch-based input can be effected by means of a mouse and/or a touch display. Additionally or alternatively, the audible input can be effected by means of a voice input, in particular recording of the voice input, and/or a microphone.

In one development, in particular one configuration, of the invention, step a) comprises, or involves: ascertainment, in particular automated ascertainment, in particular recording and/or receiving, of a component and/or assembly-group identifier, in particular a value of the component and/or assembly-group identifier, in particular a component and/or assembly-group serial number, in particular a value of the component and/or assembly-group serial number, and/or a component and/or assembly-group type number, in particular a value of the component and/or assembly-group type number, for identifying the component and/or the assembly group and/or the component and/or assembly-group type. Step b) comprises, or involves: determination, in particular automated determination, of the number of possible actions, in particular the information about the number of possible actions, and/or the number of required actions, in particular the information about the number of required actions, where available, on the basis of the ascertained component and/or assembly-group identifier, in particular the ascertained value of the component and/or assembly-group identifier, in particular the ascertained component and/or assembly-group serial number, in particular the ascertained value of the component and/or assembly-group serial number, and/or the ascertained component and/or assembly-group type number, in particular the ascertained value of the component and/or assembly-group type number. Additionally or alternatively, the ascertainment of the tool type, where present, comprises, or involves: ascertainment, in particular automated ascertainment, in particular recording and/or receiving, of a tool identifier, in particular a value of the tool identifier, in particular a tool serial number, in particular a value of the tool serial number, and/or a tool type number, in particular a value of the tool type number, for identifying the tool and/or the tool type. Step b) comprises, or involves: determination, in particular automated determination, of the number of possible actions, in particular the information about the number of possible actions, and/or the number of required actions, in particular the information about the number of required actions, where available, on the basis of the ascertained tool identifier, in particular the ascertained value of the tool identifier, in particular the ascertained tool serial number, in particular the ascertained value of the tool serial number, and/or the ascertained tool type number, in particular the ascertained value of the tool type number. Additionally or alternatively, the determination of the plurality of possible component and/or assembly-group types, where present, comprises, or involves: determination, in particular automated determination, of the plurality of possible component and/or assembly-group types, in particular the information about the plurality of possible component and/or assembly-group types, on the basis of the ascertained tool identifier, in particular the ascertained value of the tool identifier, in particular the ascertained tool serial number, in particular the ascertained value of the tool serial number, and/or the ascertained tool type number, in particular the ascertained value of the tool type number.

In one development, in particular one configuration, of the invention, step a) comprises, or involves, an optical recording, in particular an automated optical recording, of at least one component and/or assembly-group piece of the component and/or assembly group and/or of the component and/or assembly-group identifier, in particular the value of the component and/or assembly-group identifier, where available. Additionally or alternatively, the ascertainment of the tool type, where present, comprises, or involves, an optical recording, in particular an automated optical recording, of at least one tool piece of the tool and/or of the tool identifier, in particular the value of the tool identifier, where available. This allows a high level of repair friendliness. In particular, the optical recording can be effected by means of code reading, in particular barcode reading and/or 2D code reading, and/or image recognition.

In one development of the invention, the tool comprises, or has, a motor drive system. The component and/or assembly group have/has been handled during, in particular for, the repair of the motor drive system, in particular by the repairer, in particular directly. The number of possible actions is carried out during, in particular for, the repair of the motor drive system. In particular, the motor drive system can comprise, or in particular be, an internal combustion engine drive system and/or an electrical motor drive system, in particular a storage battery motor drive system. Additionally or alternatively, the tool can comprise a machining tool and the motor drive system can be designed to drive the machining tool.

In one development of the invention, the tool is a saw, a pole pruner, a brush cutter, hedge shears, a hedge cutter, a blower device, a leaf blower, a lopper, a separation grinder, a sweeping device, a sweeping roller, a sweeping brush, a lawnmower, in particular a robot lawnmower or a sit-on lawnmower, a scarifier, grass shears, a wood chipper, a stone cutter, a high-pressure cleaner or a sprayer and/or spraying device.

The, in particular electrical, system according to the invention is designed, or configured, for automated assistance with a, in particular the, recording of a, in particular the, repair of a, in particular the, motor-driven tool, in particular for carrying out a, in particular the, method as described above. The system comprises, or has, an, in particular electrical, ascertainment device, an, in particular electrical, determination device and an, in particular electrical, output device. The ascertainment device is designed, or configured, for, in particular automated, ascertainment of at least one, in particular the at least one, component of the tool and/or at least one, in particular the at least one, assembly group of the tool and/or at least one, in particular the at least one, component and/or assembly-group type of at least one, in particular the at least one, component and/or at least one, in particular the at least one, assembly group, wherein the component and/or the assembly group have/has been handled during the repair of the tool. The determination device is designed, or configured, for, in particular automated, determination of a, in particular the, number of possible actions carried out during the repair of the tool on the basis of the ascertained component and/or the ascertained assembly group and/or the ascertained component and/or assembly-group type. The output device is designed, or configured, for, in particular automated, output of the determined number of possible actions.

In particular, the tool and/or the component and/or the assembly group can, in particular in each case, be partially or completely designed as described above.

The ascertainment device, the determination device and/or the output device can be designed to be separate from the tool. In other words: the ascertainment device, the determination device and/or the output device do/does not need to or may not be part of the tool.

The system can comprise a mobile, in particular portable, or hand-portable, device, the device being able to comprise the ascertainment device, the determination device and/or the output device. In particular, the mobile device can be designed to be separate from the tool. In other words: the mobile device does not need to or may not be part of the tool.

In one development of the invention, the ascertainment device comprises, or has, an, in particular electrical, input device for a touch-based and/or audible input and/or a, in particular electrical, recording device for optical recording. In particular, the input device can comprise, in particular be, a, in particular the, mouse, a, in particular the, touch display and/or a, in particular the, microphone. Additionally or alternatively, the recording device can comprise a reader, in particular a camera.

In one development of the invention, the system comprises, or has, the component and/or the assembly group and/or the tool.

Further advantages and aspects of the invention emerge from the claims and from the following description of preferred exemplary embodiments of the invention, which are explained below with reference to the figures.

### BRIEF DESCRIPTION OF THE DRAWINGS

FIG. 1 shows a schematic view of a method according to the invention involving an ascertainment, in particular a recording, and of a system according to the invention comprising an ascertainment device, in particular a recording device, and a motor-driven tool.

FIG. 2 shows a schematic view of a handling, or an action, in particular a swapping, and of the system of FIG. 1 comprising a component.

FIG. 3 shows another schematic view of the method of FIG. 1 involving an ascertainment, in particular a recording, and of the system of FIG. 1 comprising the ascertainment device, in particular the recording device.

FIG. 4 shows another schematic view of the method of FIG. 1 involving the ascertainment, in particular a selection and an input, an output and a confirmation, and of the system of FIG. 1 comprising the ascertainment device, in particular an input device, and an output device.

FIG. 5 shows another schematic view of the method of FIG. 1 involving a determination, in particular a picking, a storage and an output and/or a transmission, and of the system of FIG. 1 comprising a determination device.

FIG. 6 shows another schematic view of the method of FIG. 1 involving the output and the confirmation, in particular an input, and of the system of FIG. 1 comprising the ascertainment device, in particular the input device, and the output device.

FIG. 7 shows another schematic view of the method of FIG. 1 involving the ascertainment, in particular the input, the output and the confirmation, in particular the input, and of the system of FIG. 1 comprising the ascertainment device, in particular the input device, and the output device.

FIG. 8 shows another schematic view of the method of FIG. 1 involving the ascertainment, in particular the recording, and of the system of FIG. 1 comprising the ascertainment device, in particular the input device, and the output device.

FIG. 9 shows another schematic view of the method of FIG. 1 involving an output and of the system of FIG. 1 comprising the ascertainment device, in particular the input device, and the output device.

### DETAILED DESCRIPTION OF THE DRAWINGS

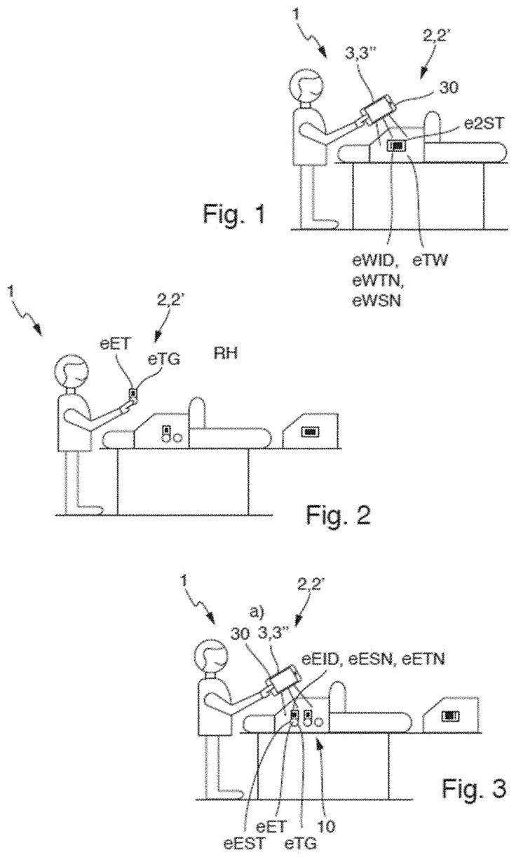

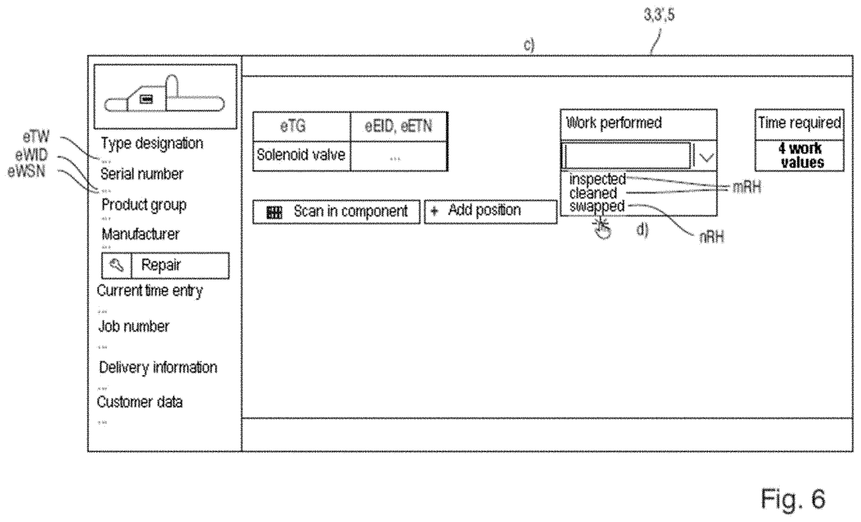

FIGS. 1 to 5 show a system 1 and FIGS. 1 and 3 to 9 show a method for automated assistance with a recording of a repair of a motor-driven tool 2.

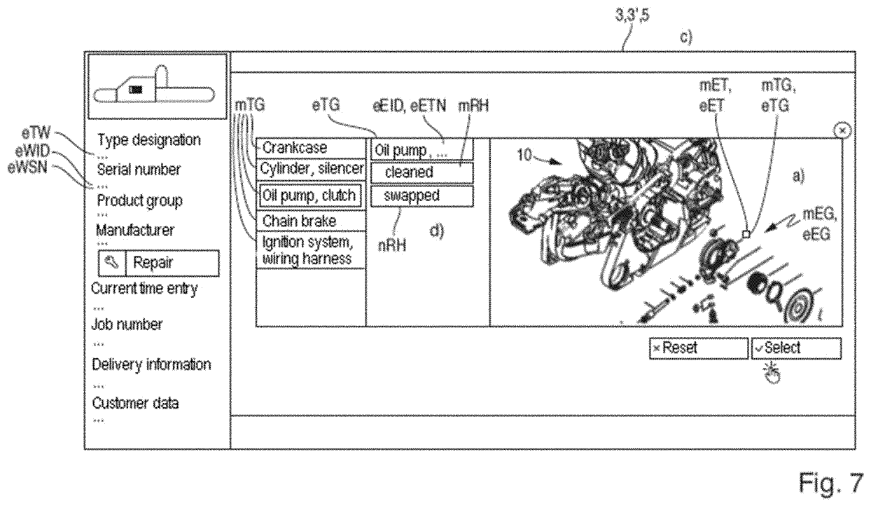

The system 1 comprises an ascertainment device 3, a determination device 4 and an output device 5. The ascertainment device 3 is designed to ascertain at least one component eET of the tool 2, as shown in FIGS. 2, 3 and 8, and/or at least one assembly group eEG of the tool 2, as shown in FIG. 7, and/or at least one component and/or assembly-group type eTG of the at least one component eET and/or the at least one assembly group eEG, wherein the component eET and/or the assembly group eEG have/has been handled during the repair of the tool 2, in particular by a repairer of the tool 2. The determination device 4 is designed to determine a number of possible actions mRH, in particular by the repairer, carried out during the repair of the tool 2 on the basis of the ascertained component eET and/or the ascertained assembly group eEG and/or the ascertained component and/or assembly-group type eTG. The output device 5 is designed to output the determined number of possible actions mRH, in particular to the repairer.

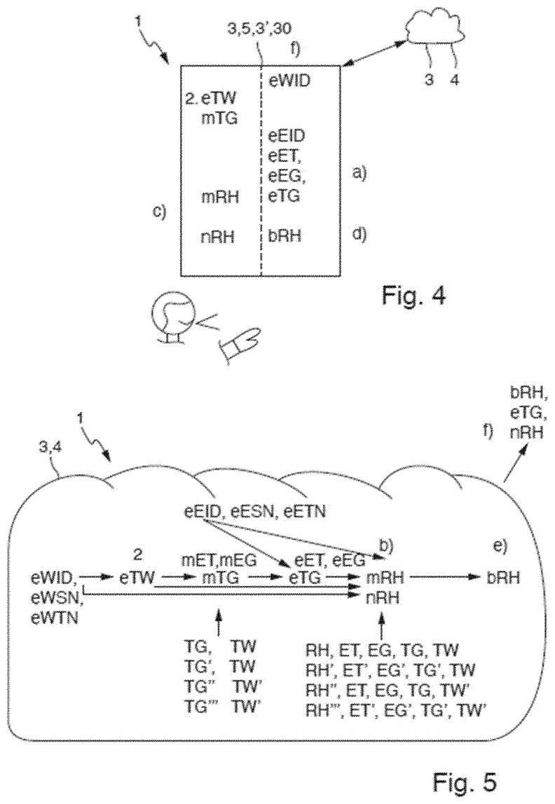

The method involves the steps of: a) ascertainment of the at least one component eET of the tool 2 and/or of the at least one assembly group eEG of the tool 2 and/or of the at least one component and/or assembly-group type eTG of the at least one component eET and/or the at least one assembly group eEG, wherein the component eET and/or the assembly group eEG have/has been handled during the repair of the tool 2, in particular by means of the ascertainment device 3, as shown in FIGS. 3, 7 and 8; b) determination of the number of possible actions mRH carried out during the repair of the tool 2 on the basis of the ascertained component eET and/or the ascertained assembly group eEG and/or the ascertained component and/or assembly-group type eTG, in particular by means of the determination device 4, as shown in FIG. 5; c) output of the determined number of possible actions mRH, in particular by means of the output device 5, as shown in FIGS. 4, 6 and 7.

In the exemplary embodiment shown, the system 1 has a mobile device 30, in particular in the form of a smartphone, as shown in FIGS. 1, 3 and 4. The mobile device 30 comprises the ascertainment device 3 and the output device 5, in particular in the form of a display, in particular a touch display.

In addition, the determination device 4 is in the form of a cloud server.

Additionally, the ascertainment device 3 and the determination device 4 are designed, in particular assigned, for, in particular wireless, transmission of the ascertained component eET and/or the ascertained assembly group eEG and/or the ascertained component and/or assembly-group type eTG.

Further, the determination device 4 and the output device 5 are designed, in particular assigned, for, in particular wireless, transmission of the number of possible actions mRH.

In detail, the ascertainment device 3 has an input device 3′, in the form of the touch display and a microphone in the exemplary embodiment shown, for touch-based and/or audible input and/or a recording device 3″, in the form of a reader, in particular a camera, in the exemplary embodiment shown, for optical recording.

In alternative exemplary embodiments, the ascertainment device can additionally or alternatively comprise, in particular be, a table having a touch display.

Moreover, the system 1 comprises the component eET and/or the assembly group eEG and/or the tool 2.

In the exemplary embodiment shown, the tool 2 is a saw 2′, as shown in FIGS. 1 to 3.

In addition, the tool 2 comprises a motor drive system 10, as shown in FIGS. 3 and 7. The component eET and/or the assembly group eEG have/has been handled during the repair of the motor drive system 10. The number of possible actions mRH is carried out during the repair of the motor drive system 10.

In the exemplary embodiment shown, the motor drive system 10 comprises an internal combustion engine drive system, in particular is the internal combustion engine drive system.

In alternative exemplary embodiments, the motor drive system can additionally or alternatively comprise, in particular be, an electrical motor drive system, in particular a storage battery motor drive system.

In FIGS. 2 and 3, the component eET is in the form of a solenoid valve.

In FIG. 7, the assembly group eEG is in the form of an oil pump group and the component eET is in the form of an oil pump.

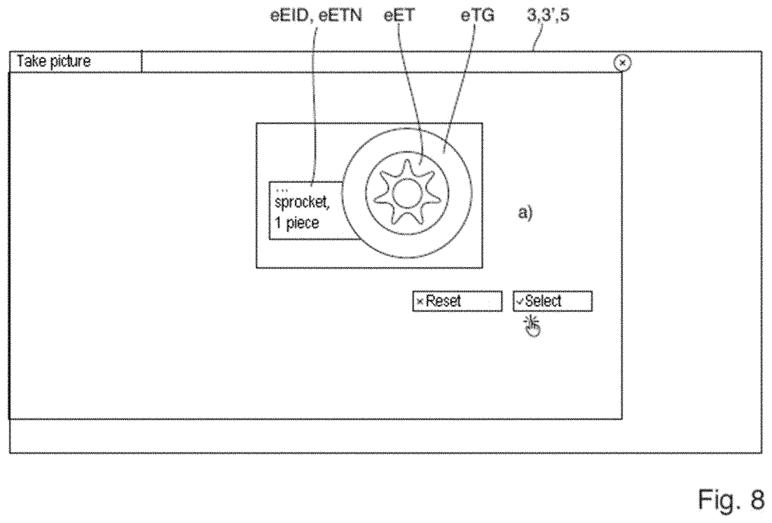

In FIG. 8, the component eET is in the form of a sprocket.

Additionally, the number of possible actions mRH is user-confirmable, in particular user-selectable. The method involves the steps of: d) confirmation, in particular selection, of at least one action bRH from the output number of possible actions mRH, in particular by the repairer, in particular by means of the input device 3′, as shown in FIGS. 4, 6 and 7; e) storage of the confirmed, in particular selected, action bRH, in particular by means of the system 1, in particular a memory of the system 1, in particular in the form of the cloud server.

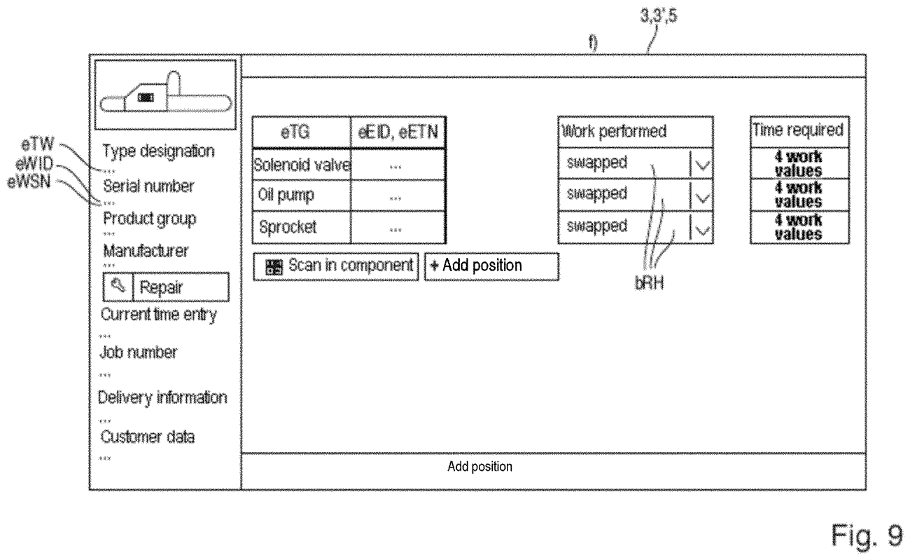

Further, the method involves the step of: f) output and/or transmission of the stored action bRH, in particular and the ascertained component eET and/or the ascertained assembly group eEG and/or the ascertained component and/or assembly-group type eTG, in particular to the repairer and/or a user of the tool 2, in particular by means of the output device 5 and/or the cloud server, as shown in FIGS. 5 and 9.

Moreover, step b) involves: determination of a number of required actions nRH, in particular by the repairer, carried out during the repair of the tool 2 on the basis of the ascertained component eET and/or the ascertained assembly group eEG and/or the ascertained component and/or assembly-group type eTG, in particular by means of the determination device 4, as shown in FIG. 5. Step c) and/or step f) involve/involves: output and/or transmission of the determined number of required actions nRH, in particular to the repairer and/or the user, in particular by means of the output device 5 and/or the cloud server, as shown in FIGS. 5 and 9.

In addition, the method involves the step of: ascertainment of a tool type eTW of the tool 2, in particular by means of the ascertainment device 3, as shown in FIG. 1.

Additionally, step b) involves: determination of the number of possible actions mRH and/or the number of required actions nRH on the basis of the ascertained tool type eTW, in particular by means of the determination device 4, as shown in FIG. 5.

Additionally or alternatively, the method involves the step of: determination of a user-selectable plurality of possible component and/or assembly-group types mTG of possible components mET and/or possible assembly groups mEG handled during the repair of the tool 2, in particular by the repairer, on the basis of the ascertained tool type eTW, in particular by means of the determination device 4, as shown in FIG. 5. The method involves the step of: output of the determined plurality of possible component and/or assembly-group types mTG, in particular in an exploded view, in particular by means of the output device 5, as shown in FIGS. 4 and 7. Step a) involves: selection of the component and/or assembly-group type eTG from the output plurality of possible component and/or assembly-group types mTG, in particular in the exploded view, in particular by the repairer, in particular by means of the input device 3′, as shown in FIGS. 4 and 7.

Additionally, step b) involves: picking of the number of possible actions mRH and/or the number of required actions nRH from a set of different actions RH, RH′, RH″, RH′″, wherein the actions RH, RH′, RH″, RH′″ are assigned in each case at least one component ET, ET′ from a set of different components ET, ET′ and/or at least one assembly group EG, EG′ from a set of different assembly groups EG, EG′ and/or at least one component and/or assembly-group type TG, TG′ of the component ET and/or of an assembly group EG from a set of different component and/or assembly-group types TG, TG′ of components ET′ and/or assembly groups EG, in particular and at least one tool type TW, TW′ of a motor-driven tool 2 from a set of different tool types TW, TW′ of motor-driven tools 2, in particular by means of the determination device 4, as shown in FIG. 5.

Additionally or alternatively, the determination of the plurality of possible component and/or assembly-group types mTG involves: picking of the plurality of possible component and/or assembly-group types mTG from a set of different component and/or assembly-group types TG, TG′, TG″, TG′″ of components ET and/or assembly groups EG, wherein the component and/or assembly-group types TG, TG′, TG″, TG′″ are assigned in each case at least one tool type TW, TW′ of a motor-driven tool 2 from a set of different tool types TW, TW′ of motor-driven tools 2, in particular by means of the determination device 4, as shown in FIG. 5.

Further, step a) and/or step d) and/or the ascertainment of the tool type eTW involve/involves a touch-based and/or audible input, in particular by means of a voice input, in particular recording of the voice input, in particular by the repairer, in particular by means of the input device 3′, in the form of the touch display and the microphone in the exemplary embodiment shown, as shown in FIGS. 4 and 7.

Moreover, step a) involves: ascertainment of a component and/or assembly-group identifier eEID, in particular a component and/or assembly-group serial number eESN and/or a component and/or assembly-group type number eETN, for identifying the component eET and/or the assembly group eEG and/or the component and/or assembly-group type eTG, in particular by means of the ascertainment device 3, as shown in FIGS. 3 and 8. Step b) involves: determination of the number of possible actions mRH and/or the number of required actions nRH on the basis of the ascertained component and/or assembly-group identifier eEID, in particular the ascertained component and/or assembly-group serial number eESN and/or the ascertained component and/or assembly-group type number eETN, in particular by means of the determination device 4.

Additionally or alternatively, the ascertainment of the tool type eTW involves: ascertainment of a tool identifier eWID, in particular a tool serial number eWSN and/or a tool type number eWTN, for identifying the tool 2 and/or the tool type eTW, in particular by means of the ascertainment device 3, as shown in FIG. 1.

Additionally, step b) involves: determination of the number of possible actions mRH and/or the number of required actions nRH on the basis of the ascertained tool identifier eWID, in particular the ascertained tool serial number eWSN and/or the ascertained tool type number eWTN, in particular by means of the determination device 4.

Additionally or alternatively, the determination of the plurality of possible component and/or assembly-group types involves: determination of the plurality of possible component and/or assembly-group types mTG on the basis of the ascertained tool identifier eWID, in particular the ascertained tool serial number eWSN and/or the ascertained tool type number eWTN, in particular by means of the determination device 4.

In addition, step a) involves an optical recording of at least one component and/or assembly-group piece eEST of the component eET and/or the assembly group eEG, in particular by means of image recognition, and/or of the component and/or assembly-group identifier eEID, in particular by means of code reading, in particular by means of the recording device 3″, in the form of the reader, in particular the camera, in the exemplary embodiment shown, as shown in FIGS. 3 and 8.

Additionally or alternatively, the ascertainment of the tool type eTW involves an optical recording of at least one tool piece e2ST of the tool 2, in particular by means of image recognition, and/or of the tool identifier eWID, in particular by means of code reading, in particular by means of the recording device 3″, in the form of the reader, in particular the camera, in the exemplary embodiment shown, as shown in FIG. 1.

In alternative exemplary embodiments, the ascertainment device and the tool can be designed, in particular assigned, for, in particular wireless, transmission of the tool identifier.

In the exemplary embodiment shown, the component eET is a replacement part and/or the assembly group eEG is a replacement group, the replacement part eET and/or the replacement group eEG having been swapped in the tool 2 during the repair of the tool 2. Therefore, the number of required actions nRH comprises a number of required swapping actions, in particular for the swapped component eET and/or the swapped assembly group eEG. The number of possible actions mRH comprises a number of possible cleaning and/or inspection actions, in particular for the replaced component and/or the replaced assembly group.

Additionally, the number of possible actions can comprise a number of possible cleaning and/or inspection actions for one and/or another component, in particular of the same assembly group, and/or assembly group that is functionally related to, or interacts with, the component eET and/or the assembly group eEG, in particular precedes said component and/or assembly group.

By way of example, the assembly group may possibly have been cleaned and inspected at a time before the swapping action for the component eET in the form of the solenoid valve, which is a component of a carburettor assembly group.

If multiple, in particular mutually independent, components and/or multiple, in particular mutually independent, assembly groups have been handled during the repair of the tool, the method can be carried out iteratively.

As the exemplary embodiments shown and explained above clarify, the invention provides an advantageous method for automated assistance with a recording of a repair of a motor-driven tool and an advantageous system for automated assistance with a recording of a repair of a motor-driven tool, each of which has improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for automated assistance with a recording of a repair of a motor-driven tool, the method comprising the steps of:
a) ascertaining at least one component of the tool, at least one assembly group of the tool, and/or at least one component and/or assembly-group type of at least one component and/or at least one assembly group, wherein the component and/or the assembly group has been handled during the repair of the tool;
b) determining a number of possible actions carried out during the repair of the tool based on the ascertained component, the ascertained assembly group, and/or the ascertained component and/or assembly-group type; and
c) outputting the determined number of possible actions.

2. The method according to claim 1,
wherein the number of possible actions is user-confirmable, and
wherein the method further comprises the steps of:
d) confirming at least one action from the output determined number of possible actions; and
e) storing the confirmed action.

3. The method according to claim 2, wherein the method further comprises the step of:
f) outputting and/or transmitting the stored confirmed action, and the ascertained component, the ascertained assembly group, and/or the ascertained component and/or assembly-group type.

4. The method according to claim 3,
wherein step b) involves: determining a number of required actions carried out during the repair of the tool on the basis of the ascertained component, the ascertained assembly group, and/or the ascertained component and/or assembly-group type, and
wherein step c) and/or step f) involves: outputting and/or transmitting the determined number of required actions.

5. The method according to claim 4,
wherein the method further comprises the step of: ascertaining a tool type of the tool, and
wherein step b) involves: determining the number of possible actions and/or the number of required actions on the basis of the ascertained tool type.

6. The method according to claim 1, wherein the method further comprises the steps of:
ascertaining a tool type of the tool,
determining a user-selectable plurality of possible component and/or assembly-group types of possible components and/or possible assembly groups handled during the repair of the tool on the basis of the ascertained tool type,
outputting the determined plurality of possible component and/or assembly-group types, and
wherein step a) involves: selecting the component and/or assembly-group type from the output plurality of possible component and/or assembly-group types.

7. The method according to claim 4,
wherein step b) involves: picking the number of possible actions and/or the number of required actions from a set of different actions, wherein the actions are assigned in each case at least one component from a set of different components, at least one assembly group from a set of different assembly groups, and/or at least one component and/or assembly-group type of a component and/or an assembly group from a set of different component and/or assembly-group types of components and/or assembly groups, including at least one tool type of a motor-driven tool from a set of different tool types of motor-driven tools, and/or
wherein the determination of the plurality of possible component and/or assembly-group types involves: picking the plurality of possible component and/or assembly-group types from a set of different component and/or assembly-group types of components and/or assembly groups, wherein the component and/or assembly-group types are assigned in each case at least one tool type of a motor-driven tool from a set of different tool types of motor-driven tools.

8. The method according to claim 5,
wherein step a), step d), and/or the ascertainment of the tool type involves a touch-based or audible input.

9. The method according to claim 5, wherein at least one of:
(i) step a) involves: ascertainment of a component and/or assembly-group identifier including a component and/or assembly-group serial number, and/or a component and/or assembly-group type number, for identifying the component and/or the assembly group and/or the component and/or assembly-group type, and wherein step b) involves: determination of the number of possible actions and/or the number of required actions on the basis of the ascertained component and/or assembly-group identifier, or
(ii) the ascertainment of the tool type involves: ascertainment of a tool identifier, including a tool serial number and/or a tool type number, for identifying the tool and/or the tool type, and wherein step b) involves: determination of the number of possible actions and/or the number of required actions on the basis of the ascertained tool identifier, and/or wherein the determination of the plurality of possible component and/or assembly-group types involves: determination of the plurality of possible component and/or assembly-group types on the basis of the ascertained tool identifier.

10. The method according to claim 5,
wherein step a) involves an optical recording of at least one component and/or assembly-group piece of the component and/or the assembly group and/or of the component and/or assembly-group identifier, and/or
wherein the ascertainment of the tool type involves an optical recording of at least one tool piece of the tool and/or of the tool identifier.

11. The method according to claim 1,
wherein the tool comprises a motor drive system, and
wherein the component and/or the assembly group has been handled during the repair of the motor drive system, and
wherein the number of possible actions is carried out during the repair of the motor drive system.

12. The method according to claim 1,
wherein the tool is a saw, a pole pruner, a brush cutter, hedge shears, a hedge cutter, a blower device, a leaf blower, a lopper, a separation grinder, a sweeping device, a sweeping roller, a sweeping brush, a lawnmower, a scarifier, grass shears, a wood chipper, a stone cutter, a high-pressure cleaner or a sprayer.

13. The method according to claim 6,
wherein step b) involves: picking the number of possible actions and/or the number of required actions from a set of different actions, wherein the actions are assigned in each case at least one component from a set of different components, at least one assembly group from a set of different assembly groups and/or at least one component and/or assembly-group type of a component and/or an assembly group from a set of different component and/or assembly-group types of components and/or assembly groups, including at least one tool type of a motor-driven tool from a set of different tool types of motor-driven tools, and/or
wherein the determination of the plurality of possible component and/or assembly-group types involves: picking the plurality of possible component and/or assembly-group types from a set of different component and/or assembly-group types of components and/or assembly groups, wherein the component and/or assembly-group types are assigned in each case at least one tool type of a motor-driven tool from a set of different tool types of motor-driven tools.

14. The method according to claim 6,
wherein step a), step d), and/or the ascertainment of the tool type involves a touch-based or audible input.

15. The method according to claim 6, wherein at least one of:
(i) step a) involves: ascertainment of a component and/or assembly-group identifier including a component and/or assembly-group serial number, and/or a component and/or assembly-group type number, for identifying the component and/or the assembly group and/or the component and/or assembly-group type, and wherein step b) involves: determination of the number of possible actions and/or the number of required actions on the basis of the ascertained component and/or assembly-group identifier, or
(ii) the ascertainment of the tool type involves: ascertainment of a tool identifier, including a tool serial number and/or a tool type number, for identifying the tool and/or the tool type, and wherein step b) involves: determination of the number of possible actions and/or the number of required actions on the basis of the ascertained tool identifier, and/or wherein the determination of the plurality of possible component and/or assembly-group types involves: determination of the plurality of possible component and/or assembly-group types on the basis of the ascertained tool identifier.

16. A system for automated assistance with a recording of a repair of a motor-driven tool, wherein the system comprises:
an ascertainment device, wherein the ascertainment device is configured to ascertain at least one component of the tool, at least one assembly group of the tool and/or at least one component and/or assembly-group type of at least one component and/or at least one assembly group, wherein the component and/or the assembly group has been handled during the repair of the tool;
a determination device, wherein the determination device is configured to determine a number of possible actions carried out during the repair of the tool on the basis of the ascertained component, the ascertained assembly group and/or the ascertained component and/or assembly-group type; and
an output device, wherein the output device is configured to output the determined number of possible actions.

17. The system according to claim 16,
wherein the ascertainment device comprises an input device for a touch-based or audible input, and/or comprises a recording device for optical recording.

18. The system according to claim 16, wherein the system comprises:
the component and/or the assembly group, and/or
the tool.
